(19) United States
(12) Patent Application Publication
(10) Pub. No.: US 2010/0257466 A1
(43) Pub. Date: Oct. 7, 2010

(54) METHOD AND SYSTEM FOR GENERATING A MINI-SOFTWARE APPLICATION CORRESPONDING TO A WEB SITE

(75) Inventors: Luke Wroblewski, San Jose, CA (US); Aramys Miranda, San Jose, CA (US); John Greene, Portland, OR (US)

Correspondence Address: YAHOO! INC. C/O GREENBERG TRAURIG, LLP, MET LIFE BUILDING, 200 PARK AVENUE, NEW YORK, NY, 10166, US

(73) Assignee: Yahoo! Inc., Sunnyvale, CA (US)

(21) Appl. No.: 12/416,720

(22) Filed: Apr. 1, 2009

(51) Int. Cl. G06F 3/048; G06F 17/30

(52) U.S. Cl. 715/760; 715/764; 707/E17.108

(57) ABSTRACT

The automatic generation of a mini-application corresponding to a web site is disclosed. A web site is identified via a Uniform Resource Locator (URL). The web site is analyzed via a computing device to determine its functionality, where the functionality includes features and functions of the web site. The computing device extracts a subset of the web site functionality based on characteristics of the web site. A mini-application corresponding to the web site is then automatically generated by computer code executing on the computing device. The mini-application includes the extracted subset of the web site functionality so that the subset of the web site functionality is accessible when the mini-application executes.

### FIELD

The present disclosure relates to software and, more specifically, to generating mini-applications that correspond to web sites.

### BACKGROUND

The Internet is comprised of many web sites to which users can navigate. When a user decides that the user may want to return to a particular web site that the user has navigated to, the user may decide to save the Uniform Resource Locator (URL) of the web site as a bookmark. To navigate to a particular web site again, a user typically either inputs the URL of the web site into the address bar of user's web browser, or selects the bookmark associated with the particular web site.

Some websites contain mini-applications corresponding to other web sites. For example, the Yahoo!® web site may contain a mini-application that has some of the functionality (e.g., links) of the actual CNN® news web site. The user can then utilize the functionality available in the mini-application without having to navigate to the actual CNN® web site.

### SUMMARY

The present disclosure relates to the automatic generation of a mini-application corresponding to a web site, which automatic generation can be initiated by user request. A web site is identified via a Uniform Resource Locator (URL). The web site is analyzed, via a computing device, to determine its functionality, where the functionality includes features and functions of the web site. The computing device extracts a subset of the web site functionality. This extracting step may be based on characteristics of the web site and/or user characteristics or requirements. A mini-application corresponding to the web site is then automatically generated by computer code executing on the computing device. The mini-application includes the extracted subset of the web site functionality so that the subset of the web site functionality is accessible when the mini-application executes. As used herein, mini-applications can also be called mini-websites or super bookmarks.

In one embodiment, a representation of the mini-application is visibly displayed in a graphical user interface (GUI) on a display. The representation of the mini-application may be, for example, a thumbnail of the web site and a title. Upon receiving a selection of the representation of the mini-application, the mini-application is visibly displayed in the GUI on the display.

In one embodiment, the identifying of the web site via the URL includes receiving, from a user, the URL. In another embodiment, the identifying of the web site via the URL includes receiving, from a user, a search query and determining the URL from the received search query. In one embodiment, the features of the web site include web site links on the web site. The analyzing of the web site to determine its functionality further includes identifying and/or retrieving web pages of the web site, e.g. deep links to specific portions, articles, media or pages of the website. In one embodiment, the analyzing the web site to determine its functionality further includes identifying a title of the web site, identifying a description of the web site, and identifying a thumbnail of the web site.

In one embodiment, the mini-application includes an application restricted search box which enables the searching of the mini-application or a search restricted to the website from which the mini-application was generated. In one embodiment, structured search results are generated in response to a search via the application restricted search box in the mini-application.

In one embodiment, the web site characteristics include an amount of web traffic associated with different links on the web site. In one embodiment, the extracting step includes extracting a Really Simple Syndication (RSS) feed from the web site.

These and other aspects and embodiments will be apparent to those of ordinary skill in the art by reference to the following detailed description and the accompanying drawings.

### BRIEF DESCRIPTION OF THE DRAWINGS

In the drawing figures, which are not to scale, and where like reference numerals indicate like elements throughout the several views:

FIG. 1 is a block diagram of a first computing device communicating with a second computing device over a network to request and receive a mini-application corresponding to a particular web site in accordance with an embodiment of the present disclosure;

FIG. 2 is a flowchart of the steps performed by the first and/or second computing device(s) of FIG. 1 to generate the mini-application in accordance with an embodiment of the present disclosure;

FIG. 3 is a block diagram of a mini-application and its corresponding web page in accordance with an embodiment of the present disclosure;

FIG. 4 is a high level block diagram of a computing device in accordance with an embodiment of the present disclosure; and

FIG. 5 is a screen shot of a mini-application in accordance with an embodiment of the present disclosure.

### DESCRIPTION OF EMBODIMENTS

Embodiments are now discussed in more detail referring to the drawings that accompany the present application. In the accompanying drawings, like and/or corresponding elements are referred to by like reference numbers.

Various embodiments are disclosed herein; however, it is to be understood that the disclosed embodiments are merely illustrative of the invention that can be embodied in various forms. In addition, each of the examples given in connection with the various embodiments is intended to be illustrative, and not restrictive. Further, the figures are not necessarily to scale, some features may be exaggerated to show details of particular components (and any size, material and similar details shown in the figures are intended to be illustrative and not restrictive). Therefore, specific structural and functional details disclosed herein are not to be interpreted as limiting, but merely as a representative basis for teaching one skilled in the art to variously employ the disclosed embodiments.

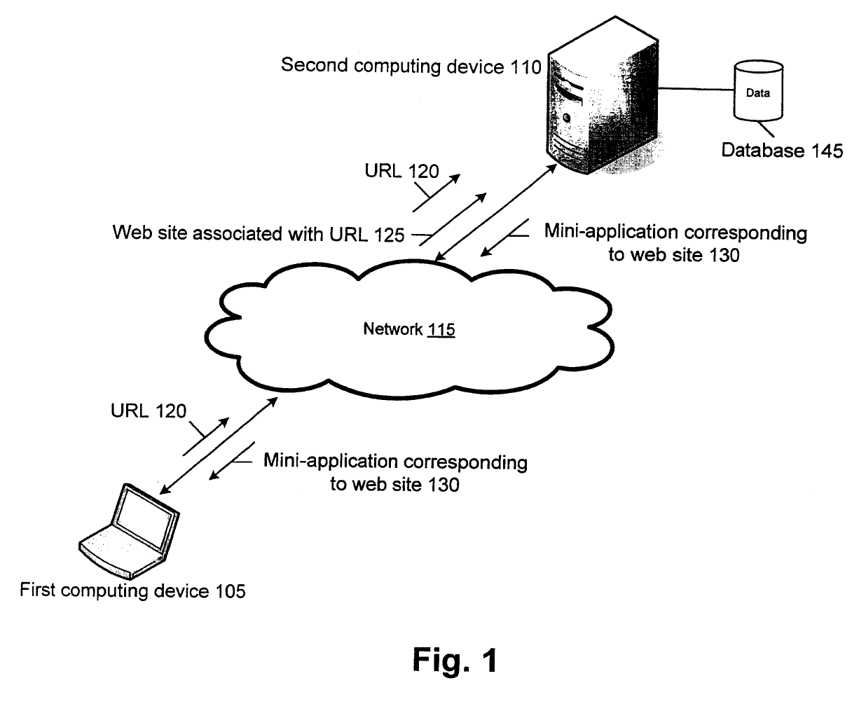

FIG. 1 shows a block diagram of an embodiment of a system 100 having a first computing device 105 in communication with a second computing device 110 over a network 115, such as the Internet. The first computing device 105 transmits a URL 120 corresponding to a web site to the second computing device 110 over network 115. In one embodiment, a user of the first computing device 105 uses a web browser on the first computing device 105 to access a particular web site. In one embodiment, the web site contains an input box in which the user can type in a URL of interest.

When the second computing device 110 receives the URL 120 of interest, the second computing device 110 retrieves the web site 125 associated with the URL 120 from the network 115. The second computing device 110 then analyzes the web site 125 to determine its functionality. In one embodiment, the second computing device 110 identifies (and/or retrieves) web pages of the web site. In one embodiment, the second computing device 110 identifies a title of the web site, a description of the web site, and/or a thumbnail of the web site. The second computing device 110 then automatically generates a mini-application 130 corresponding to the web site 125. The mini-application 130 includes a subset of the web site's functionality. The second computing device 110 transmits the mini-application 130 to the first computing device 105 so that the user of the first computing device 105 can execute the mini-application.

In one embodiment, the second computing device 110 is in communication with a database 145. As described in more detail below, the second computing device 110 can retrieve information from the database 145 during the generation of the mini-application 130. Although shown as being connected to the second computing device 110, the database 145 may instead be connected to another component, such as a component in the network 115 or the first computing device 105. If, for example, the database is connected to the first computing device 105, the first computing device 105 can retrieve particular information from the database 145 and then transmit this information to the second computing device 110.

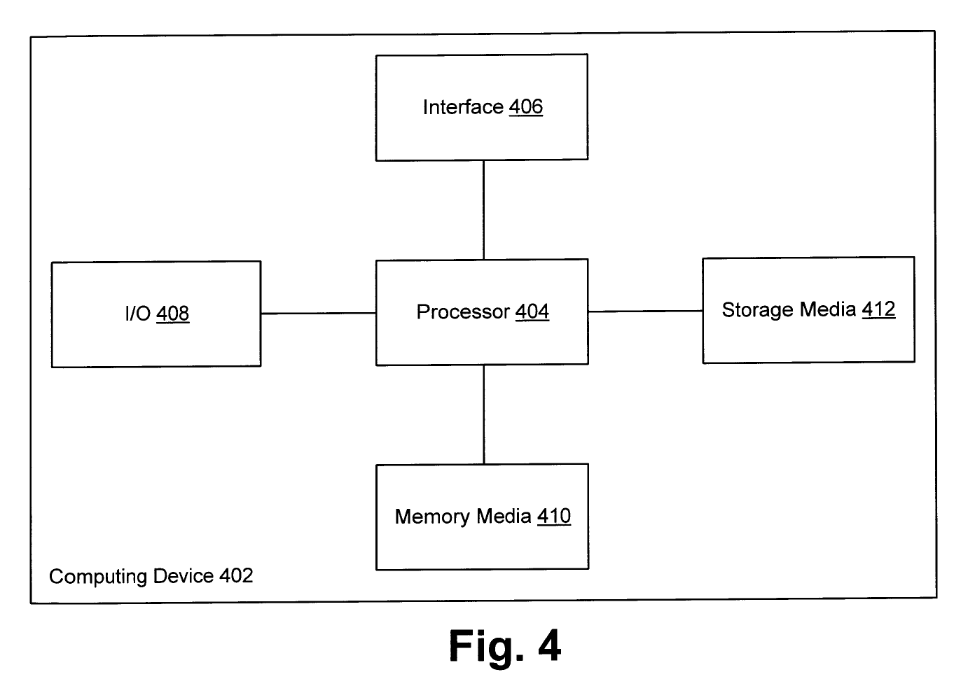

For purposes of this disclosure, (See e.g. FIG. 4) a computer or computing device such as the first and/or second computing device 105, 110 includes a processor and memory for storing and executing program code, data and software which may be stored or read from computer readable media. Computers can be provided with operating systems that allow the execution of software applications in order to manipulate data. Personal computers, personal digital assistants (PDAs), wireless devices, cellular telephones, internet appliances, media players, home theater systems, servers, and media centers are several non-limiting examples of computing devices. The computing device 105, 110 can also include a display, such as a screen or monitor.

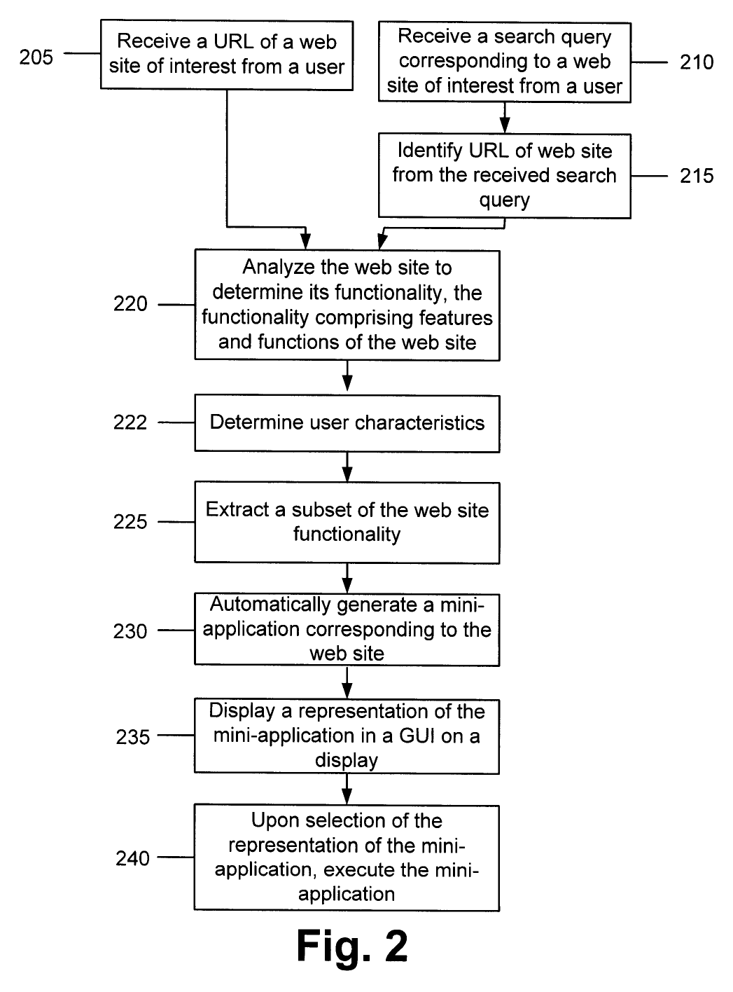

FIG. 2 is a flowchart illustrating an embodiment of the steps performed to generate a mini-application. In one embodiment, the first computing device 105 receives (e.g., as input on a web-based form) a URL of a web site of interest from a user (step 205). In another embodiment, the first computing device 105 receives, in step 210, a search query corresponding to a web site of interest from a user. The first computing device 105 then identifies the URL of a web site from the received search query in step 215. The first computing device 105 transmits the URL to the second computing device 110, as described above. In another embodiment, the second computing device 110 performs the operations of step 205 and/or steps 210-215.

As described above, the second computing device 110 retrieves the web site of interest and then analyzes the web site (step 220) to determine its functionality, where the functionality includes the features and functions of the web site, including without limitation web pages, articles, RSS feeds, audio or video media, or images. In one embodiment, the second computing device 110 determines user characteristics of the user of the first computing device 105 (step 222). For example, the second computing device 110 may retrieve these user characteristics from a user database (e.g., database 145), that contains user preferences. For example, the user database may reflect a user's affinity for sports, or certain cars. Such information can be factored into what web site features are extracted for that user. The process can also include if desired a form of request that permits the user to input particular characteristics the user desires to be reflected in the mini application, e.g. into a web form. Once the second computing device 110 has retrieved the user's characteristics and or preference information, the second computing device 110 can use these user characteristics when generating the mini-application.

The second computing device 110 extracts a subset of the web site functionality (step 225) in accordance with a set of extraction rules. In one embodiment and as described in more detail below, the second computing device 110 extracts the subset of the web site functionality from the web site based on certain characteristics of the web site. In another embodiment, the second computing device 110 extracts the subset of the web site functionality from the web site based in part or totally on the user characteristics. In yet another embodiment, the second computing device 110 extracts the subset of the web site functionality from the web site based on both the user characteristics and the web site characteristics. In one embodiment, the extracting step includes extracting a Really Simple Syndication (RSS) feed from the web site. The second computing device 110 automatically generates a mini-application corresponding to the web site (step 230). The mini-application includes the extracted subset of the web site functionality.

For example, suppose a user of the first computing device 105 is a sports fanatic who often navigates to sports-related web sites, or frequently searches for sports-related topics. The user also typically selects sports-related links after navigating to a news-related web site such as www.cnn.com. Such information could be made available from the user database discussed above or other similar data repository, or obtained by direct query of the user as part of the application generation process. The second computing device 110, in generating a mini-application corresponding to the CNN® news site for that sports-conscious user, would preferably include many sports-related links and/or functions in the mini-application so generated. This can be achieved, for example, by parsing web pages on the site to analyze their content for sports-related terms or names, or via tags, or via consulting a database with web site information that is useable to identify content or topic-specific deep links, pages or media found on a web site.

In one embodiment, the first computing device 105 displays, in step 235, a representation of the mini-application in a graphical user interface (GUI) on its display, such as a thumbnail of the web site associated with the mini-application. Upon selection of the representation (e.g., thumbnail) of the mini-application, the second computing device 110 executes (step 240) and displays the mini-application on the display of the first computing device 110. Alternatively, the second computing device 110 transmits the mini-application to the first computing device 105 and, when a user selects (e.g., clicks) the representation of the mini-application, the first computing device 105 executes and displays the mini-application.

Thus, in one embodiment a mini application or super bookmark is constructed for a URL on the web. This super bookmark can be integrated into another software product (toolbars, mail clients, starting points, customized or personalized home pages such as for example MY YAHOO! etc.). A super bookmark consists of an integrated component that includes direct links to a URL, site-restricted search for that URL, a listing of any RSS headlines for that URL, a set of “deep” navigational links for that URL, and a screen shot of the URL. This super bookmark/ mini-application can thus be embedded in other software products. The mini-application enables people to have quick access, robust search capabilities, and up to date news from a single URL with a single component that is built on the fly. These mini-applications are built on the fly and require little to no work on the user's part.

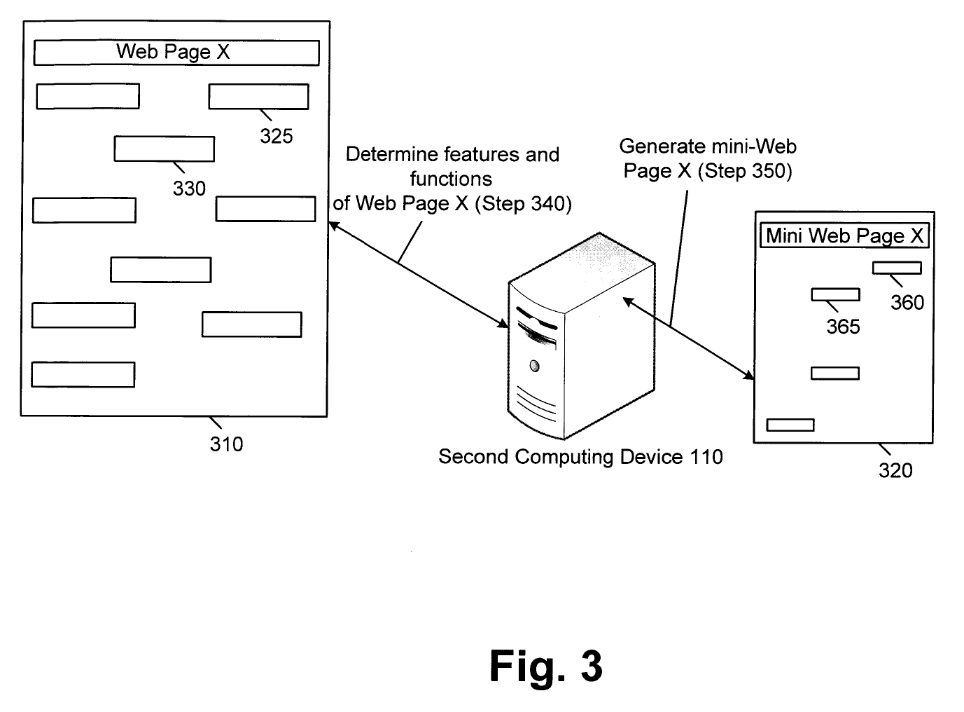

FIG. 3 illustrates a block diagram of a web page X 310 and its corresponding mini-application 320. The web page X 310 includes many web objects, such as web object 325 and web object 330. Each web object (e.g., web object 325 and 330) can be, for example, a picture, text, a link, etc. Second computing device 110 determines the features and functions of web page X 310 in step 340. The features of web page X 310 can include, for example, its layout and design (e.g., of the objects), its style, etc. The functions of the web page X 310 can include, for example, the functions of the web objects such as web object 325, 330.

After determining the features and functions of web page X 310 in step 340, the second computing device 110 generates, in step 350, mini-web page X 320. The mini-web page X 320 also includes web objects, such as web object 360 and web object 365. In one embodiment, the mini-web page X 320 includes a portion of the web objects present in the web page X 310. For example, the mini-web page X 320 includes web object 360, which corresponds to web object 325 in web page X 310. Similarly, the mini-web page X 320 includes web object 365, which corresponds to web object 330 in web page X 310.

For example, if web object 325 of web page X 310 is a link to another web page, web object 360 can be the same link to the same web page. In one embodiment, the mini-web page X 320 only includes a subset of the web objects present in web page X 310. In one embodiment, the second computing device 110 determines which objects (e.g. deep links, media, RSS feeds, etc) to include in the mini-web page X 320 based on characteristics of the web page X 310 and/or based on characteristics of the user. The characteristics of the web page X 310 include, for example, the amount of web traffic (i.e., its popularity) associated with each web object on the web page X 310, the location of each web object on the web page X 310, the layout and/or design of the web page X 310, etc. Thus the rule set can include rules to extract some number of the five most popular pages on the site, one or more of the most requested video content, page links that appear at or near the top of the web site home page, or that contain certain keywords, or that have specific associated tags. The rule set can also take into account characteristics associated with the user. These can be the user's preferences and may be determined, for example, from the user's past navigation history or a user database maintained by one or more web sites, or may be derived from explicit or implicit user behavior. For example, a user's past navigation history can indicate that the user likes sports. The second computing device 110 can then include web objects in the mini-web page X 320 that are associated with sports for this particular user.

In one embodiment, one of the web objects on the mini-web page X 320 (such as web object 360) is an application restricted search box. The application restricted search box enables searching of the mini-application, or the site from which the mini-application was generated, rather than the World Wide Web at large. The degree of restriction may be adjusted, or the user may be presented with a follow-up dialog asking if the user would prefer to expand the search beyond the mini-application. In one embodiment, the mini-web page X 320 generates structured search results in response to a search of the mini-web page X 320 via the application restricted search box. In particular, search results are typically displayed in an unstructured manner, with text describing the web page being displayed as a link to the search result web page. In one embodiment, structured search results include a bulleted list of search results. Structured search results can include search results formatted in any manner, such as via bullets or tabs.

An embodiment of pseudocode representing software code executed by the second computing device 110 and/or the first computing device 105 to automatically generate a mini-application is as follows:

```
  If URL is not empty
    Load dependencies
    Create unique module identifier string to associate with app
    Fetch website data (e.g., RSS FEED, INLINKS, and/or PAGE
DATA (Title, Url, Description))
    Create new data object with result
    Fetch DEEP LINKS for website
    Append DEEP LINKS to data object
    Loop start at first offset go to last offset for every item in
deeplink list
      Concatenate deeplink HTML list string
    End Loop
    Loop start at first offset go to last offset for every item in page
data object
      Switch
        Case ‘INLINKS’
          Concatenate INLINKS HTML list string
        Case ‘RSS FEED’
          Concatenate RSS FEED HTML list
string
        Case ‘PAGE DATA’
          Concatenate PAGE DATA [Title,
Description] HTML list string
      End Switch
    End Loop
    Begin Rendering App
      Begin Header
        Create url for thumbnail image creation
        Print PAGE DATA [Title, Description]
        Print DEEP LINKS HTML list string
        Print PAGE DATA [Url]
        Print Search Enabled searchbox for site
restricted search
      End Header
      Begin Body
        If RSS FEED has image
          Print RSS FEED with images
        Else
          Print RSS FEED without
        End If
      End Body
      Begin Footer
        Print Search Enabled searchbox for site
restricted search
      End Footer
    End Rendering App
  End If
```

The description herewith describes the present invention in terms of the processing steps required to implement an embodiment of the invention. These steps can be performed by an appropriately programmed computing device or computer, the configuration of which is well known in the art. An appropriate computing device can be implemented, for example, using well known computer processors, memory units, storage devices, computer software, and other components. A high level block diagram of such a computing device is shown in FIG. 4. Computing device 402 is an example of computing device 105 and/or computing device 110 of FIG. 1 and contains a processor 404 which controls the overall operation of computing device 402 by executing computer program instructions which define such operation. The computer program instructions can be tangibly stored in a storage media 412 (e.g., magnetic or optical disk or other computer readable medium now known or to become known) and loaded into memory media 410 or read directly from media 410 when execution of the computer program instructions is desired. Computing device 402 also includes one or more interfaces 406 for communicating with other devices (e.g., locally or via a network). Computing device 402 also includes input/output 408 that represent devices that allow for user interaction with the computing device 402 (e.g., display, keyboard, mouse, speakers, buttons, etc.).

One skilled in the art will recognize that an implementation of an actual computing device will contain other components as well, and that FIG. 4 is a high level representation of some of the components of such a computing device for illustrative purposes, which may be, for example, a personal computer, PDA, wireless device, internet appliance, cellular telephone, or such processor driven technology. In addition, the processing steps described herein can also be implemented using dedicated hardware, the circuitry of which is configured specifically for implementing such processing steps. Alternatively, the processing steps can be implemented using various combinations of hardware, firmware and software.

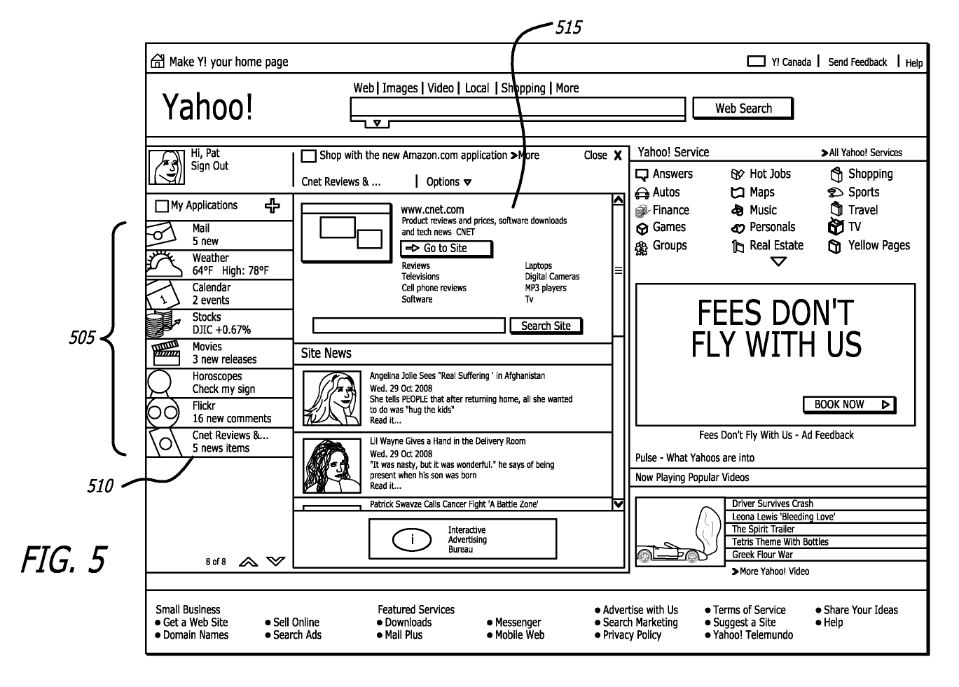

FIG. 5 is a screen shot of an embodiment of a mini-applications such as a mini-application for the web site www.cnet.com. The screen shot shows a plurality of mini-applications 505 that the user has generated. When the user selects a representation 510 of a mini-application 510 corresponding to www.cnet.com, the mini-application 515 executes in a display area. The mini-application 515 enables the user to access particular functionality of the actual web site (www.cnet.com), search the mini-application, as well as navigate to the actual web site (in this example, www.cnet.com).

Those skilled in the art will recognize that the methods and systems of the present disclosure can be implemented in many manners and as such are not to be limited by the foregoing exemplary embodiments and examples. In other words, functional elements being performed by single or multiple components, in various combinations of hardware and software or firmware, and individual functions, can be distributed among software applications at either the first or second computers or server or both. In this regard, any number of the features of the different embodiments described herein can be combined into single or multiple embodiments, and alternate embodiments having fewer than, or more than, all of the features described herein are possible. Functionality can also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that can be made to the hardware or software or firmware components described herein as would be understood by those skilled in the art now and hereafter.

The foregoing Description is to be understood as being in every respect illustrative and exemplary, but not restrictive, and the scope of the invention disclosed herein is not to be determined from the Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

What is claimed is:

1. A method comprising:
identifying a web site via a Uniform Resource Locator (URL);
analyzing, via a computing device, the web site to determine its functionality, the functionality comprising features and functions of the web site;
extracting, via the computing device, a subset of the web site functionality in accordance with a set of extraction rules; and
automatically generating, by computer code executing on the computing device, a mini-application corresponding to the web site and in accordance with said extraction rules, the mini-application comprising the extracted subset of the web site functionality so that the subset of the web site functionality is accessible when the mini-application executes.

2. The method of claim 1 further comprising visibly displaying a representation of the mini-application in a graphical user interface (GUI) on a display.

3. The method of claim 2 further comprising, upon receiving a selection of the representation of the mini-application, visibly displaying the mini-application in the GUI on the display.

4. The method of claim 2 wherein the representation of the mini-application comprises a thumbnail image of the web site.

5. The method of claim 1 wherein the identifying a web site via a URL further comprises receiving, from a user, the URL.

6. The method of claim 1 wherein the identifying a web site via a URL further comprises:
receiving, from a user, a search query; and
determining the URL from the received search query.

7. The method of claim 1 wherein the features of the web site further comprise deep web site links on the web site.

8. The method of claim 1 wherein analyzing the web site to determine its functionality further comprises identifying content on web pages of the web site.

9. The method of claim 1 wherein the identifying the web pages of the web site further comprises retrieving the web pages.

10. The method of claim 1 wherein the analyzing the web site to determine its functionality further comprises identifying a title of the web site, identifying a description of the web site, and identifying a thumbnail image of the web site.

11. The method of claim 1 wherein the mini-application comprises an application restricted search box, the application restricted search box enabling searching of the mini-application.

12. The method of claim 11 further comprising generating structured search results in response to a search of the mini-application via the application restricted search box.

13. The method of claim 1 wherein the mini-application comprises an application restricted search box, the application restricted search box enabling searching of the web site.

14. The method of claim 1 wherein the extracting step further comprises extracting, via the computing device, a subset of the web site functionality based on characteristics of the web site.

15. The method of claim 14 wherein the web site characteristics further comprise an amount of web traffic associated with different links on the web site.

16. The method of claim 1 wherein the extracting step further comprises extracting a Really Simple Syndication (RSS) feed from the web site.

17. The method of claim 1 wherein the extracting step further comprises obtaining user preference data and utilizing the user preference data as a factor in the extraction rules so as to extract web site functionality related to the user preference data.

18. A computer readable medium storing computer program instructions capable of being executed by a computer processor on a computing device, the computer program instructions defining the steps of:
identifying a web site via a Uniform Resource Locator (URL);
analyzing the web site to determine its functionality, the functionality comprising features and functions of the web site;
extracting a subset of the web site functionality in accordance with a set of extraction rules; and
automatically generating a mini-application corresponding to the web site and in accordance with said extraction rules, the mini-application comprising the extracted subset of the web site functionality so that the subset of the web site functionality is accessible when the mini-application executes.

19. The computer readable medium of claim 18 further comprising computer program instructions defining the step of visibly displaying a representation of the mini-application in a graphical user interface (GUI) on a display.

20. The computer readable medium of claim 19 further comprising computer program instructions defining the step of, upon receiving a selection of the representation of the mini-application, visibly displaying the mini-application in the GUI on the display.

21. The computer readable medium of claim 19 wherein the representation of the mini-application comprises a thumbnail image of the web site.

22. The computer readable medium of claim 18 wherein the computer program instructions defining the step of identifying a web site via a URL further comprises computer program instructions defining the step of receiving, from a user, the URL.

23. The computer readable medium of claim 18 wherein the computer program instructions defining the step of identifying a web site via a URL further comprises computer program instructions defining the steps of
receiving, from a user, a search query; and
determining the URL from the received search query.

24. The computer readable medium of claim 18 wherein the features of the web site further comprise deep web site links on the web site.

25. The computer readable medium of claim 18 wherein the computer program instructions defining the step of analyzing the web site to determine its functionality further comprises computer program instructions defining the steps of identifying content on web pages of the web site.

26. The computer readable medium of claim 18 wherein the computer program instructions defining the step of identifying the web pages of the web site further comprises computer program instructions defining the step of retrieving the web pages.

27. The computer readable medium of claim 18 wherein the computer program instructions defining the step of analyzing the web site to determine its functionality further comprises computer program instructions defining the step of identifying a title of the web site, identifying a description of the web site, and identifying a thumbnail image of the web site.

28. The computer readable medium of claim 18 wherein the mini-application comprises an application restricted search box, the application restricted search box enabling searching of the mini-application.

29. The computer readable medium of claim 28 further comprising computer program instructions defining the step of generating structured search results in response to a search of the mini-application via the application restricted search box.

30. The computer readable medium of claim 18 wherein the computer program instructions defining the extracting step further comprises computer program instructions defining the step of extracting a subset of the web site functionality based on characteristics of the web site.

31. The computer readable medium of claim 18 wherein the computer program instructions defining the extracting step further comprises computer program instructions defining the step of extracting a subset of the web site functionality based on user characteristics.

32. The computer readable medium of claim 18 wherein the computer program instructions defining the extracting step further comprises computer program instructions defining the step of obtaining user preference data and utilizing the user preference data as a factor in the extraction rules so as to extract web site functionality related to the user preference data.
